(19) United States
(12) Patent Application Publication
(10) Pub. No.: US 2005/0067282 A1
(43) Pub. Date: Mar. 31, 2005

(54) Sensor element

(76) Inventors: Berndt Cramer, Leonberg (DE); Bernd Schumann, Rutesheim (DE); Joerg Ziegler, Rutesheim (DE)

Correspondence Address: KENYON & KENYON, ONE BROADWAY, NEW YORK, NY, 10004, US

(21) Appl. No.: 10/947,022

(22) Filed: Sep. 21, 2004

(30) Foreign Application Priority Data
Sep. 29, 2003 (DE) 103 45 142.0

(51) Int. Cl. G01N 27/26

(52) U.S. Cl. 204/424; 204/426

(57) ABSTRACT

A sensor element is used to determine a physical property of a measuring gas, which may be to determine the concentration of a component of an exhaust gas of an internal combustion engine. The sensor element includes a first electrode, which is positioned on a solid electrolyte and which is connected to the measuring gas located outside the sensor element via a first diffusion pathway, in which a first diffusion resistor is provided. The sensor element also has a second electrode, which is positioned on a solid electrolyte and is connected to the measuring gas located outside the sensor element via a second diffusion pathway, in which a second diffusion resistor is positioned. The second diffusion resistor includes a catalytically active material.

### FIELD OF THE INVENTION

The present invention is directed to a sensor element.

### BACKGROUND INFORMATION

A planar sensor element is referred to in Automotive Electronics Handbook, Editor: Ronald Jurgen, Chapter 6, McGraw-Hill, 1995, for example. The planar sensor element has a first and a second solid electrolyte film, between which a measuring gas chamber is introduced. A diffusion barrier is connected upstream from the measuring gas chamber. The measuring gas located outside the sensor element may reach the measuring gas chamber via a measuring gas opening introduced into the first solid electrolyte film and via the diffusion barrier.

An internal pump electrode and a Nernst electrode are positioned in the measuring gas chamber. The internal pump electrode forms an electrochemical pump cell together with an external pump electrode applied to an external surface of the sensor element and the region of the first solid electrolyte film lying between the internal pump electrode and the external pump electrode. The Nernst electrode works together with a reference electrode subjected to a reference gas and with the solid electrolyte positioned between the Nernst electrode and the reference electrode; the cited elements form an electrochemical Nernst cell, via which the oxygen partial pressure in the measuring gas chamber is determined.

By applying a pumping voltage, oxygen is pumped into or out of the measuring gas chamber by the pump cell in such a way that there is an oxygen partial pressure of approximately lambda=1 in the measuring gas chamber. For this purpose, the pumping voltage is regulated using analysis electronics in such a way that the Nernst voltage applied to the Nernst cell corresponds to a setpoint value of 450 mV, for example. In the event of lean exhaust gas, all of the oxygen flowing through the diffusion barrier is pumped off by the pump cell because of this regulation. Since the quantity of oxygen flowing through the diffusion barrier is a measure of the oxygen partial pressure of the measuring gas, the oxygen partial pressure in the measuring gas may be concluded on the basis of the pumping current. In the event of rich exhaust gas, oxidizable components of the measuring gas (such as hydrocarbons, H₂, CO) flow through the diffusion barrier into the measuring gas chamber. The oxidizable components of the measuring gas react with the oxygen pumped into the measuring gas chamber by the pump cell. The oxygen partial pressure in the exhaust gas may again be determined on the basis of the pumping current.

The described determination of the oxygen partial pressure assumes that the measuring gas is in thermodynamic equilibrium. If this is not the case, oxidizable and reducible gas components exist next to one another, so the measurement result is corrupted, since the oxidizable and the reducible gas components have different diffusion constants and therefore diffuse at different speeds through the diffusion barrier into the measuring gas chamber. A similar effect occurs in the event of rich exhaust gas, in which there are almost no reducible components. Rich exhaust gas contains, for example, the components H₂, CO, and hydrocarbons (multicomponent measuring gas). The proportions of the different components may vary, however.

Since the different components have different diffusion coefficients, the measurement result is corrupted in the event of different compositions of a rich exhaust gas. Unbalanced measuring gases or multicomponent measuring gases of this type particularly occur during the regeneration phase of diesel particle filters or in rich exhaust gas, during the regeneration of an NOₓ accumulator-type catalytic converter, for example.

Furthermore, providing a region of the diffusion barrier with a catalytically active material is referred to in German patent document no. 100 13 82. The reaction of the oxidizable components with the reducible components of the unbalanced measuring gas is accelerated by the catalytically active material, in such a way that the measuring gas is in thermodynamic equilibrium after flowing through the region of the diffusion barrier having the catalytically active material. In a similar way, the catalytically active material causes a reaction of the components of the multicomponent measuring gas, after which the multicomponent measuring gas is in a defined composition (essentially H₂ and CO), which is largely independent of the original composition. For this purpose, it is believed to be necessary for the average diffusion speed of the measuring gas into or out of the measuring gas chamber to be slowed, so that the measuring gas is subjected to the catalytically active material for a sufficiently long time. It may be disadvantageous in this case that the response rate of the sensor element to a change of the oxygen partial pressure in the measuring gas is worsened by reducing the diffusion speed.

### SUMMARY OF THE INVENTION

In contrast, the sensor element according to the present invention, as described herein, is believed to have the advantage that the sensor element may measure the oxygen partial pressure of the measuring gas with an outstanding response rate, and precise measurement of the oxygen partial pressure is simultaneously possible, even in the event of unbalanced measuring gas or multicomponent measuring gas, i.e., if the measuring gas is not provided in thermodynamic equilibrium and therefore in a largely defined composition.

For this purpose, the sensor element has a first electrode, which the measuring gas reaches via a first diffusion pathway, a first diffusion resistor lying in the first diffusion pathway, and the sensor element has a second electrode, which the measuring gas reaches via a second diffusion pathway, a second diffusion resistor lying in the second diffusion pathway. The second diffusion resistor has a catalytically active material and, in the event of an unbalanced measuring gas, causes a reaction of the oxidizable components with the reducible components of the measuring gas. Therefore, the measuring gas flowing to the second electrode is in thermodynamic equilibrium, so that precise determination of the oxygen partial pressure may be achieved at the second electrode, even in the event of unbalanced or multicomponent measuring gases.

Advantageous refinements of the sensor elements are described herein.

The first diffusion resistor may have only a small proportion of catalytically active material or none at all and is designed in such a way that the average diffusion speed through the first diffusion resistor is greater than the average diffusion speed through the second diffusion resistor, in particular as the result of an appropriate choice of the pore proportion and pore size of the first and second diffusion barriers. The measurement signal which is produced using the first electrode thus has a high response rate.

The catalytically active material may be provided on the side of the second diffusion resistor facing away from the second electrode. The measuring gas diffusing along the second diffusion pathway to the second electrode is thus put in thermodynamic equilibrium by the catalytically active material and diffused as a balanced measuring gas through the second diffusion resistor or through a large part of the second diffusion resistor. With a construction of this type, the different diffusion constants of the oxidizable and reducible components of the measuring gas play no role in the measurement of the oxygen partial pressure, since the oxidizable and reducible components of the measuring gas have reacted with one another (until reaching thermodynamic equilibrium), before the measuring gas diffuses through the second diffusion resistor (or a large part thereof) into the second measuring gas chamber. A multicomponent gas accordingly has a largely defined ratio of its components upon entering the second measuring gas chamber because of the reaction in the region of the catalytically active material.

The catalytically active material may have a noble metal such as platinum, palladium, or rhodium or an alloy of at least two of these elements or a mixture of at least two of these elements and is applied to the surface of a porous carrier.

The first and second diffusion resistors and/or the first and second electrodes and/or the first and second measuring gas chambers may be positioned laterally next to one another in relation to the longitudinal axis of the sensor element. It is believed to be advantageous in this case that the thermal distribution of the heated sensor element is equal in the region of the first and second diffusion resistors and/or in the region of the first and second electrodes due to the symmetrical arrangement in relation to the longitudinal axis.

In an exemplary embodiment of the present invention, a first measuring gas chamber, in which the first electrode is positioned, and a second measuring gas chamber, in which the second electrode is positioned; are provided between a first and a second solid electrolyte layer. A gas access opening is introduced into the first solid electrolyte layer. The measuring gas may reach the first electrode via a first diffusion pathway, which includes the gas access opening, the first diffusion resistor, and the first measuring gas chamber. Correspondingly, the measuring gas reaches the second electrode via a second diffusion pathway, which also includes the gas access opening, the second diffusion resistor having the catalytically active material, and the second measuring gas chamber.

In an exemplary embodiment, the first and second electrodes, the first and second diffusion resistors, and the first and second measuring gas chambers are shaped like sectors of circular rings. The region of the second diffusion resistor is also shaped like a sector of a circular ring. The sector angle may be in the range from 130 to 170 degrees. In a configuration of this type, the diffusion cross section increases linearly from the gas access opening toward the first and second electrodes, thereby advantageously softening pressure pulses in the measuring gas, which would otherwise lead to corruption of the measurement results.

The sensor element has a first pump cell, which is formed by the first electrode and a pump electrode which is positioned on the outer surface of the first solid electrolyte film. Furthermore, the sensor element contains a second pump cell, which is formed by the second electrode and the pump electrode. Furthermore, the sensor element has a first Nernst cell, which is formed by the first electrode and a reference electrode subjected to a reference gas, and a second Nernst cell, which is formed by the second electrode and the reference electrode. The first pump cell and the first Nernst cell form a first measurement unit, and the second pump cell and the second Nernst cell form a second measurement unit, the two measurement units operating independently of one another and each providing an independent measurement result.

### BRIEF DESCRIPTION OF THE DRAWINGS

FIG. 1 shows a longitudinal section of a sensor element along line I-I in FIG. 2 as a first exemplary embodiment.

FIG. 2 shows a cross section of the first exemplary embodiment along line II-II in FIG. 1.

FIG. 3 shows a longitudinal section of a sensor element along line III-III in FIG. 4 as a second exemplary embodiment of the present invention.

FIG. 4 shows a cross section of the second exemplary embodiment along line IV-IV in FIG. 3.

FIG. 5 shows a sectional view of a third exemplary embodiment of the present invention.

### DETAILED DESCRIPTION

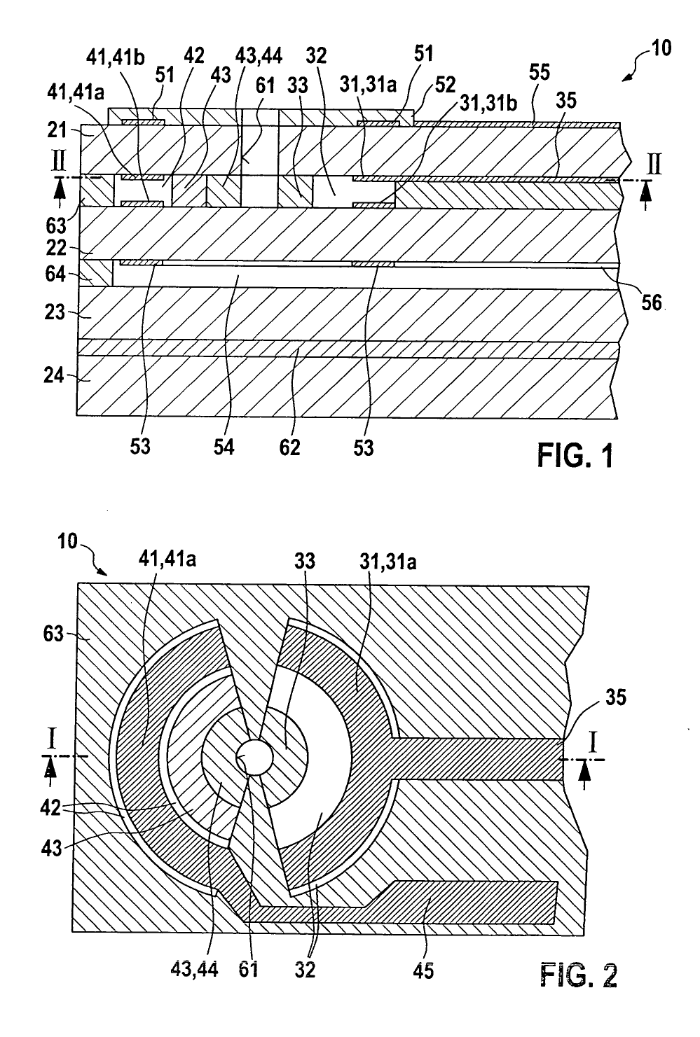

FIGS. 1 and 2 show, as a first exemplary embodiment of the present invention, the measuring region of a planar, oblong sensor element 10 constructed in layers. Sensor element 10 includes a first solid electrolyte layer 21, a second solid electrolyte layer 22, a third solid electrolyte layer 23, and a fourth solid electrolyte layer 24. A first measuring gas chamber 32 and a second measuring gas chamber 42 are provided between first and second solid electrolyte layers 21, 22. First measuring gas chamber 32 is connected to the measuring gas located outside sensor element 10 via a gas access opening 61 introduced in first solid electrolyte layer 21 and via a first diffusion resistor 33. Second measuring gas chamber 42 is connected to the measuring gas located outside sensor element 10 via gas access opening 61 and via a second diffusion resistor 43. Both measuring gas chambers 32, 42 are laterally enclosed by a sealing frame 63, which also separates measuring gas chambers 32, 42 from one another in a gas-tight manner.

In first measuring gas chamber 32, a first section 31a of first electrode 31 is applied to first solid electrolyte layer 21 and a second section 31b of first electrode 31 is applied on second solid electrolyte layer 22, diametrically opposing first section 31a of first electrode 31. First and second sections 31a, 31b of first electrode 31 are electrically connected (not shown) and connected by a shared first feed line 35, extending in the direction of a longitudinal axis of sensor element 10, to analysis electronics (also not shown), positioned outside sensor element 10.

A second electrode 41 is provided in second measuring gas chamber 42, similarly to the arrangement of first electrode 31 in first measuring gas chamber 32. Second electrode 41 includes a first section 41a, which is applied to first solid electrolyte layer 21, and a second section 41b, which is applied to second solid electrolyte layer 22 and is diametrically opposite first section 41a of second electrode 41. First and second sections 41a, 41b of second electrode 41 are also electrically connected and connected to the analysis electronics by a shared second feed line 45 extending in the direction of the longitudinal axis of sensor element 10.

A pump electrode 51, which is subjected to the measuring gas and is covered by a porous protective layer 52, is provided on the outer surface of first solid electrolyte layer 21. Pump electrode 51 is connected to the analysis electronics by a third feed line 55.

A reference gas chamber 54, which is filled with a reference gas and in which a reference electrode 53 is positioned, is provided between second and third solid electrolyte layers 22, 23. Reference gas chamber 54 is laterally enclosed by a further sealing frame 64. Reference electrode 53 is connected to the analysis electronics by a fourth feed line 56.

Pump electrode 51 and reference electrode 53 are annular. To save material, pump electrode 51 and/or reference electrode 53 may each have two sections, electrically connected to one another, which are positioned in the regions of first and second solid electrolyte layers 21, 22 diametrically opposing sections 31a, 31b, 41a, 41b of first and second electrodes 31, 41, respectively.

A heater 62 is provided between third and fourth solid electrolyte layers 23, 24, via which the measuring region of sensor element 10 shown in FIGS. 1 and 2 may be heated to an operating temperature necessary for the sensor function.

First electrode 31 acts together with pump electrode 51 as a first electrochemical pump cell and with reference electrode 53 as a first electrochemical Nernst cell. Second electrode 41 acts together with pump electrode 51 as a second electrochemical pump cell and with reference electrode 53 as a second electrochemical Nernst cell. Since sealing frame 63 is made of a solid electrolyte, which conducts oxygen ions like solid electrolyte layers 21, 22, 23, 24, first section 31a, 41a or second section 31b, 41b of first and/or second electrode 31, 41 may be dispensed with without the function of the electrochemical cells being significantly restricted.

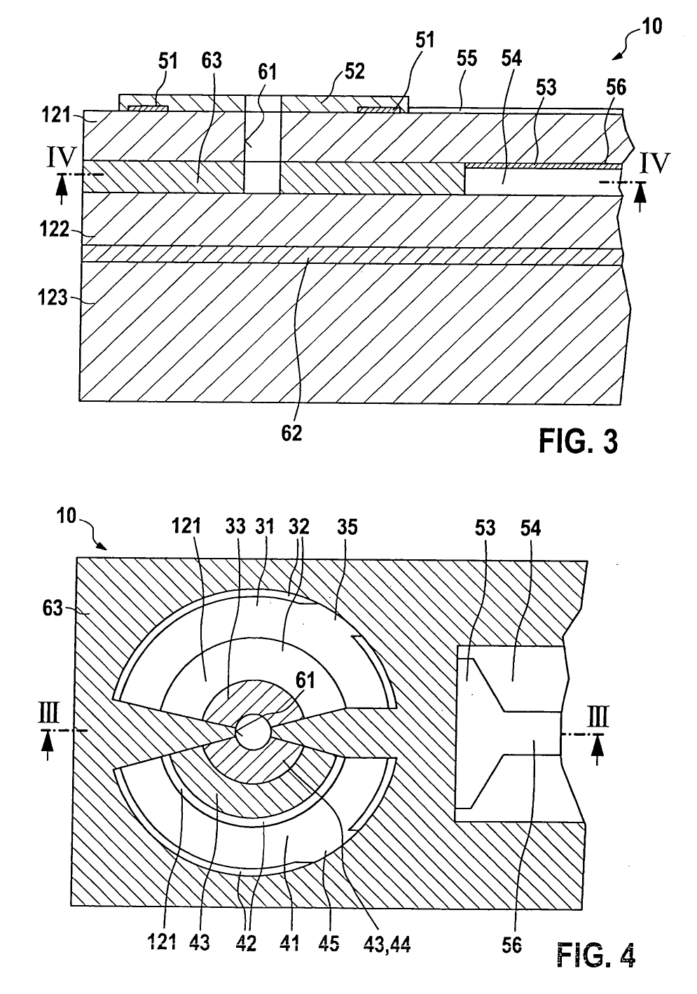

A second exemplary embodiment of the present invention, which differs from the first exemplary embodiment according to FIGS. 1 and 2 essentially in that reference gas chamber 54 is positioned in the same layer plane as first and second measuring gas chambers 32, 42, so that one solid electrolyte layer is dispensed with, and first and second measuring gas chambers 32, 42 are positioned next to one another in relation to the longitudinal axis of sensor element 10 and not, as in the first exemplary embodiment, one behind the other, is shown in FIGS. 3 and 4. Elements corresponding to one another are identified in the second exemplary embodiment by the same reference numbers as in the exemplary embodiment according to FIGS. 1 and 2.

Sensor element 10 according to the second exemplary embodiment of the present invention has a first, a second, and a third solid electrolyte layer 121, 122, 123. First and second measuring gas chambers 32, 42 and reference gas chamber 54 are positioned between first and second solid electrolyte layers 121, 122. Heater 62 is provided in a layer plane between second and third solid electrolyte layers 122, 123. First and second measuring gas chambers 32, 42 are positioned laterally next to one another in relation to the longitudinal axis of sensor element 10 and are therefore rotated by 90 degrees in relation to the configuration in the first exemplary embodiment. First and second electrodes 31, 41 are applied to first solid electrolyte layer 121, a further section of first or second electrode 31, 41 on second solid electrolyte layer 122 not being provided. Otherwise, the configuration of both measuring gas chambers 32, 42, both diffusion resistors 33, 43, and both electrodes 31, 41 (except for the configuration of first and second feed lines 35, 45) corresponds to the first exemplary embodiment.

The first and second electrochemical Nernst cells, respectively, are formed by reference electrode 53 positioned in reference gas chamber 54 and first and second electrode 31, 41, respectively, and the section of first solid electrolyte layer 121 between reference electrode 53 and first and second electrode 31, 41, respectively, and sealing frame 63.

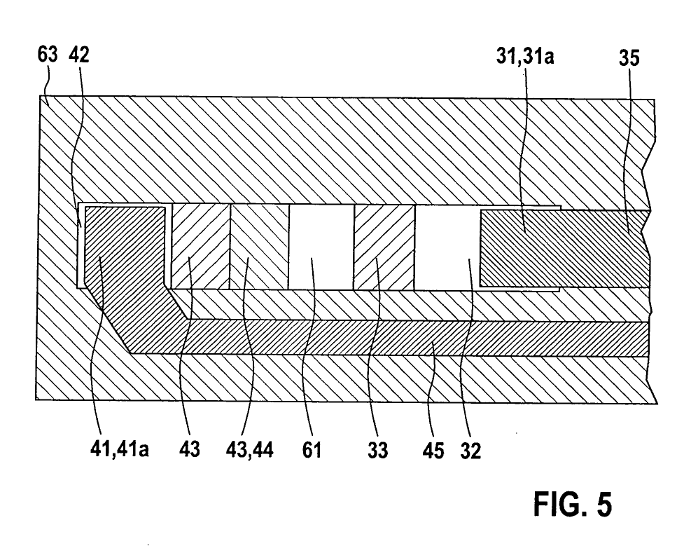

FIG. 5 shows a third exemplary embodiment of the present invention, which differs from the first and second exemplary embodiments according to FIGS. 1 through 4 essentially in that first and second diffusion resistors 33, 43 and first and second measuring gas chambers 32, 42 are positioned linearly. Elements corresponding to one another are identified in the third exemplary embodiment with the same reference numbers as in the exemplary embodiments according to FIGS. 1 through 4.

In the third exemplary embodiment, first and second diffusion resistors 33, 43 and first and second measuring gas chambers 32, 42 are positioned in an oblong, channel-shaped region, which extends in the direction of the longitudinal axis of sensor element 10 and has a largely uniform cross section. Gas access opening 61 discharges into a region between first and second diffusion resistors 33, 43. Starting from a terminal-side end of sensor element 10, first measuring gas chamber 33 having first electrode 31, 31a, first diffusion barrier 33, gas access opening 61, second diffusion barrier 43, and second measuring gas chamber 42 having second electrode 41, 41a is positioned in this channel-shaped region in the sequence specified.

In the described exemplary embodiments, second diffusion resistor 43 has a region 44 in which platinum is provided as the catalytically active material. Region 44 is positioned on the side of second diffusion resistor 43 facing away from second electrode 41. Region 44 directly adjoins gas access opening 61 in such a way that the exhaust gas may only reach second measuring gas chamber 42 via region 44 of second diffusion resistor 43. In the first and second exemplary embodiments, region 44 is implemented as a section of a circular ring, while it is implemented in the third exemplary embodiment as a rectangle and therefore with a constant length in relation to the longitudinal axis of the sensor element. Therefore, region 44 has a constant length in the exemplary embodiments in the diffusion direction of the exhaust gas, so that the exhaust gas, independent of the different diffusion pathways through second diffusion resistor 43 into second measuring gas chamber 42, always covers approximately the same distance within region 44 of second diffusion barrier 43 and is therefore subjected to the catalytically active material over an approximately constant period of time.

The exemplary embodiment and/or exemplary method of the present invention may also be transferred to sensor elements having other geometries, for example to a sensor element in which two gas access openings are provided, a first gas access opening leading to the first diffusion barrier and a second gas access opening leading to the second diffusion barrier. In this geometry, the catalytically active material may be introduced into the second diffusion barrier via a sintering process, without catalytically active material also penetrating the first diffusion barrier.

1. A sensor element for determining a physical property of a measuring gas, comprising:
a first electrode, which is positioned on a solid electrolyte and which is connected to the measuring gas located outside the sensor element via a first diffusion pathway, in which a first diffusion resistor is provided;
a second electrode, which is positioned on a solid electrolyte and which is connected to the measuring gas located outside the sensor element via a second diffusion pathway, in which a second diffusion resistor is positioned, wherein the second diffusion resistor includes a catalytically active material.

2. The sensor element of claim 1, wherein one of the following is satisfied: (i) the first diffusion resistor contains a smaller proportion of catalytically active material than the second diffusion resistor; and (ii) the first diffusion resistor contains no catalytically active material.

3. The sensor element of claim 1, wherein at least one of the following is satisfied: (i) the first diffusion resistor does not lie in the second diffusion pathway; and (ii) the second diffusion resistor does not lie in the first diffusion pathway.

4. The sensor element of claim 1, wherein the first and second diffusion resistors have a pore proportion and pore sizes such that an average diffusion speed through the first diffusion resistor is greater than the average diffusion speed through the second diffusion resistor.

5. The sensor element of claim 1, wherein the second diffusion resistor includes a region containing catalytically active material on its side facing away from the second electrode.

6. The sensor element of claim 1, wherein the first and second diffusion resistors are positioned laterally next to one another in relation to a longitudinal axis of the sensor element.

7. The sensor element of claim 1, wherein the catalytically active material includes one a noble metal.

8. The sensor element of claim 1, wherein the catalytically active material is applied to a surface of pores of a porous carrier.

9. The sensor element of claim 1, wherein the sensor element further comprises:
a first solid electrolyte layer;
a second solid electrolyte layer, wherein a first measuring gas chamber and a second measuring gas chamber are provided between the first and second solid electrolyte layers, and wherein the first electrode is positioned in the first measuring gas chamber and the second electrode is positioned in the second measuring gas chamber.

10. The sensor element of claim 9, wherein there is a gas access opening in the first solid electrolyte layer and the gas access opening forms a section of the first and second diffusion pathways.

11. The sensor element of claim 9, wherein the first and second diffusion resistors are in a layer plane between the first and second solid electrolyte layers.

12. The sensor element of claim 9, wherein at least one of the first measuring gas chamber, the second measuring gas chamber, the first diffusion resistor, the second diffusion resistor, the first electrode, and the second electrode is shaped like a sector of a circular ring.

13. The sensor element of claim 9, wherein at least one of the following is satisfied: (i) the first diffusion pathway is formed by at least the gas access opening, the first diffusion resistor, and the first measuring gas chamber; and (ii) the second diffusion pathway is formed by at least the gas access opening, the second diffusion resistor, and the second measuring gas chamber.

14. The sensor element of claim 1, further comprising:
a first electrochemical pump cell; and
a second electrochemical pump cell, the first electrochemical pump cell including a pump electrode subjected to the measuring gas, the first electrode, and a solid electrolyte positioned between the pump electrode and the first electrode, and the second electrochemical pump cell including the pump electrode, the second electrode, and a solid electrolyte positioned between the pump electrode and the second electrode.

15. The sensor element of claim 1, further comprising:
a first electrochemical Nernst cell; and
a second electrochemical Nernst cell, the first electrochemical Nernst cell including a reference electrode subjected to a reference gas, the first electrode, and a solid electrolyte positioned between the reference electrode and the first electrode, and the second electrochemical Nernst cell including the reference electrode, the second electrode, and a solid electrolyte positioned between the reference electrode and the second electrode.

16. The sensor element of claim 5, wherein a dimension of the region of the second diffusion barrier in the diffusion direction is in the range of 1 mm to 20 mm.

17. The sensor element of claim 5, wherein a dimension of the region of the second diffusion barrier in the diffusion direction is in the range of 2 mm to 5 mm.

18. The sensor element of claim 1, wherein the sensor element is for determining a concentration of a component of an exhaust gas of an internal combustion engine.

19. The sensor element of claim 1, wherein the catalytically active material includes one of platinum, palladium, rhodium, and a mixture thereof or an alloy thereof.
